(19) United States
(12) Patent Application Publication
(10) Pub. No.: US 2012/0331038 A1
(43) Pub. Date: Dec. 27, 2012

(54) SYSTEMS AND METHODS FOR PROCESSING WEB SERVICE PIPED NETWORK REQUESTS

(76) Inventor: Lin Yang, Kitchener (CA)

(21) Appl. No.: 13/167,686

(22) Filed: Jun. 23, 2011

(51) Int. Cl. G06F 15/16

(52) U.S. Cl. 709/203

(57) ABSTRACT

The embodiments described herein relate to web service client/server systems. According to some embodiments, there is provided a web service system including at least one client processor adapted to generate and transmit at least one piped request comprising a plurality of discrete requests and at least one server processor in data communication with the client processor. The at least one server processor is adapted to receive the at least one piped request comprising the discrete requests, de-pipe each discrete request from the piped request and execute each discrete request to generate a result associated with the discrete request.

### TECHNICAL FIELD

The embodiments herein relate to web services and in particular to systems and methods for processing network requests, such as HTML requests over the Internet or another communications network

### INTRODUCTION

A web service is a method of communication between two electronic devices over a network, for example the Internet. Generally, a web service is set up in a client/server relationship to perform distributed operations. For example, the Internet includes many servers and many clients. A client, such as computer connected to the Internet, can request information from the server or request that the server perform one or more actions. The server receives the request, process the received request, and responds back to the client.

The Internet is a distributed network and it is normally necessary for a request from a client to a server to include routing information so that the request is routed to the server. A common networking protocol used to route information through the Internet is the Hypertext Transfer Protocol (HTTP). Generally, each request from the client to the server, and each response from the server to the client, needs routing information such as HTTP wrappers in order to be properly transmitted and received.

### SUMMARY

According to one aspect, there is provided a web service system including at least one client processor adapted to generate and transmit at least one piped request comprising a plurality of discrete requests and at least one server processor in data communication with the client processor. The at least one server processor is adapted to receive the at least one piped request comprising the discrete requests, de-pipe each discrete request from the piped request and execute each discrete request to generate a result associated with the discrete request.

According to another aspect there is provided a web server including at least one server processor adapted to receive the at least one piped request comprising the discrete requests, de-pipe each discrete request from the piped request, and execute each discrete request to generate a result associated with the discrete request.

According to yet another aspect, there is provided a computer-implemented web service method including the steps of receiving at least one piped request comprising a plurality of discrete requests, de-piping each discrete request from the piped request, and executing each discrete request to generate a result associated with the discrete request.

### BRIEF DESCRIPTION OF THE DRAWINGS

The drawings included herewith are for illustrating various examples of systems, methods and apparatus of the present specification and are not intended to limit the scope of what is taught in any way. In the drawings:

FIG. 1 is a schematic diagram of a web service system according to some embodiments;

FIG. 2 is a schematic diagram of a client processor and a server processor of at least one of the client computers and the server shown in FIG. 1;

FIG. 3 is a schematic diagram of sub modules of a pipe controller module and a discrete request processing module shown in FIG. 2; and

FIG. 4 is a method for implementing a piped web service according to another embodiment.

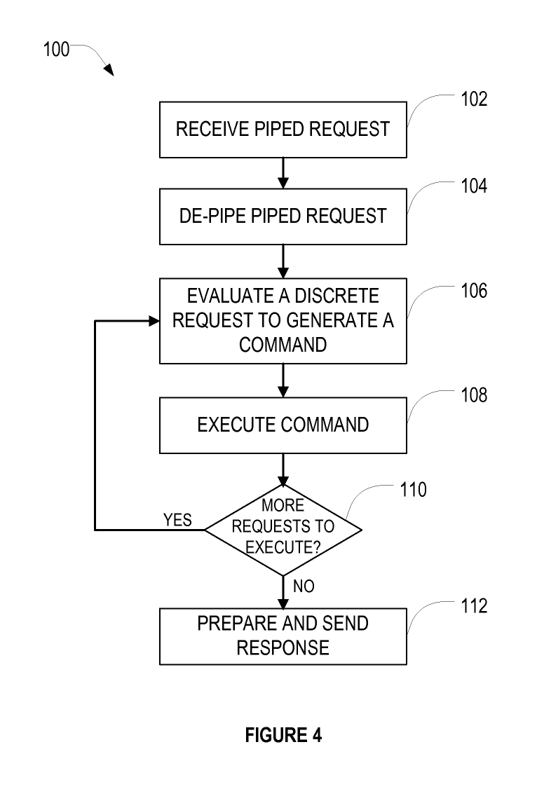

### DETAILED DESCRIPTION OF VARIOUS EMBODIMENTS

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

In some cases, the embodiments of the systems and methods described herein may be implemented in hardware or software, or a combination of both. In some cases, embodiments may be implemented in computer programs executing on programmable computing device each comprising at least one processor, a data storage device (including in some cases volatile and non-volatile memory and/or data storage elements), at least one input device, and at least one output device.

Each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium, configured with a computer program, wherein the storage medium so configured causes a computer to operate in a specific and predefined manner to perform at least some of the functions described herein.

Some embodiments as described herein generally relate to web service systems. Web service systems are implemented to perform client/server operations over a network.

Generally, web service systems are implemented over a wide area network such as the Internet. The web service system will usually include a web server that is configured to receive web requests from one or more web clients, process each request, and act in response to that request. For example, a web server may be an Internet web site and a web client may be a client computer running an Internet browser. Web service servers may also perform functionalities other than providing access to content. For example web services may be operable to facilitate online banking, electronic learning (e.g. eLearning), social networking, etc.

Generally, there may be multiple rounds of requests and responses between the web server and the web client to execute a desired functional task. For example, in a social networking environment, a functional task to add information associated with a person “John Doe” as a contact in a contact list may require two distinct operations: first, to request and receive a unique identifier (e.g. some specific alphanumeric identifier) associated with John Doe, and second, to add that unique identifier to the contact list.

Each web request and response has an overhead cost associated with it. This cost may include processing resources, such as resources associated with serializing/de-serializing, adding and removing routing information (e.g. HTTP wrappers) from a web request or response, and so on. The overhead cost may also include the network resources in terms of data usage and costs associated with the network connection. Furthermore, reducing multiple requests/responses may also reduce the overall time required to accomplish a functional task, particularly if the speed of the network transmission is relatively slow.

The web server 20 also requires processing resources to process additional numbers of requests. Accordingly, it is generally undesirable to have multiple request-response roundtrips between the web clients and the web servers to achieve a single functional task, and it may be desirable to reduce the number of requests/responses in a web service. In particular, the wrapping and de-wrapping of routing information for the requests and responses consumes processing resources of both the server and the client. Moreover, reducing the number of requests and responses also tends to reduce the overall volume of network traffic.

To reduce the need for multiple roundtrips, some web servers may provide specific or customized web service commands to achieve specific functions that are commonly performed. For example, in a social networking context, a web server may provide a web service request that permits the web client to add information associated with a person as a contact without requiring the web service client to provide the unique identifier associated with the person, thereby reducing the need for a request/response roundtrip to obtain the identifier.

Providing customized web request for functional objectives generally reduces the number of requests required to accomplish a given functional objective. However, this methodology is disadvantageous in that it requires the server to implement a large number of customized web requests for various functional tasks. This may be undesirable to the development community, which may have to familiarize itself with an ever-growing library of customized available commands.

Embodiments described herein relate generally to web service piping, which reduces the number of request-response roundtrips between the web server and web client in order to achieve a particular functional objective.

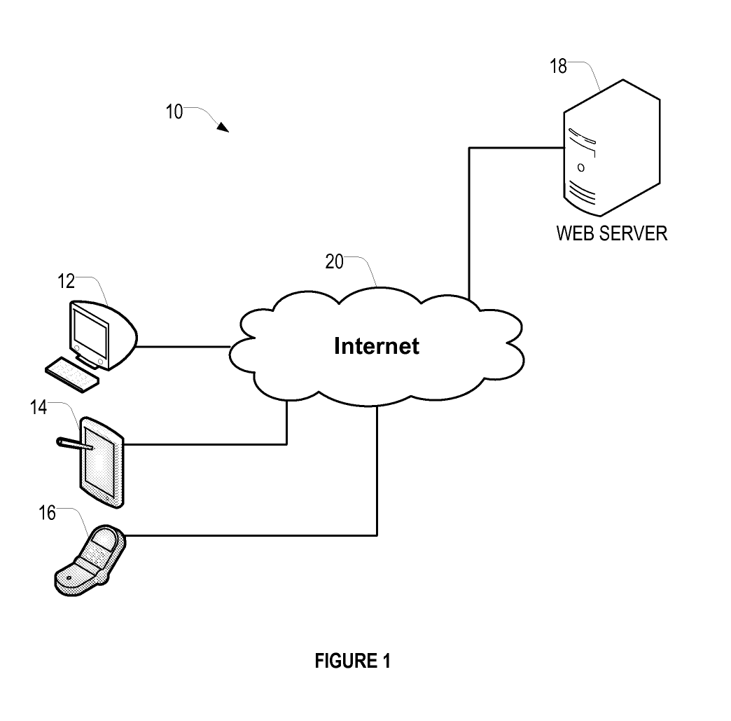

Referring now to FIG. 1, illustrated there in is a web service system 10 according to one embodiment. As shown, the web service system 10 includes client computers 12, 14, 16 connected to the server 18 via the network 20, which in the embodiment shown is the Internet. In other embodiments, the network 20 may be another form of wide area network (WAN), or a local area network (LAN).

The client computers 12, 14, 16 in this embodiment may include a desktop computer 12, a tablet or slate computer 14, and a mobile electronic device or “smart phone” 16. Generally, the number and the type of client computers may vary.

Generally, each of the client computers 12, 14 or 16 includes a client processor, a client data storage device and at least one client data communication device operable to connect to a network. For example, the data communication device may be an ethernet network modem in the desktop computer 12, and a wireless network modem compatible with an IEEE 802.11 (“WI-FI”) standard and/or a cellular data network modem (e.g. EDGE, 3G, 4G and so on) in the tablet or slate computer 14 or the mobile/smart phone 16. Data transmissions in some networks are faster than others, and the costs to transmit data in over some networks may be less or more expensive in comparison to other networks.

The web server 18 is adapted to receive one or more piped requests from the computers 12, 14, 16. The web server 18 includes a web processor and a data communication device operable to connect to the network 20. In some embodiments, the web server may also be connected to other web servers (not shown), or to a database (not shown).

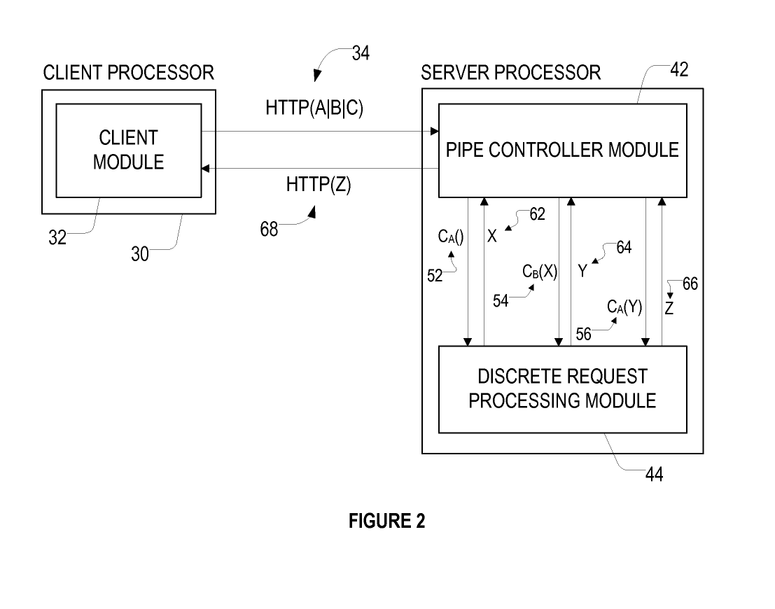

Referring now to FIG. 2, illustrated therein is a client processor 30 and a server processor 40 according to some embodiments. The client processor 30 may be a client processor found in any one or more of the client computers 12, 14, or 16. For example, the client processor may be a hardware-processing device provided on the client computer. In particular, the client processor could be desktop or laptop Core™ processor provided by Intel Corporation, processors developed for mobile computing (e.g. an Atom processor), or any other type of processors. The server processor 40 is a hardware-processing device found in the web server 20. In some embodiments, the client processor 30 and the server processor 40 may be implemented using the same type of hardware-processor but be adapted to perform different functions as described herein.

In some embodiments, each client computer 12, 14, and/or 16, or the web server 20 may include more than one processor. In some embodiments, the client processor 30 or the server processor 40 may have multiple-cores for multi-processing.

The client processor 30 is generally adapted to provide a client module 32 for generating one or more piped web request. The client module 32, for example, may be an Internet browser, or any other application that facilitates access through the network 20 to the web server 18. The Internet browser, for example, could be the Internet Explorer™ web browser application provided by Microsoft Corporation, the Firefox™ web browser application provided by Mozilla Corporation, the Safari™ web browser application provided by Apple Inc., the Chrome™ application provided by Google Inc., and so on.

Each piped web request includes a plurality of discrete requests. For example, the piped web request 34 comprises three discrete requests, namely “A”, “B” and “C” (as shown separated by a vertical slash “I”). Additionally, each piped web request generally includes routing information for transmitting the request over a network such as hypertext transfer protocol (HTTP) information, and some piped request may contain information regarding the dependency between the discrete requests. That is, some discrete requests in the piped request can only be executed once the result of one or more discrete requests has been received.

In another example, a piped web request could be:
http://localhost/Pipelines?command=˜/Bookmarks|˜/Contents/$_{—}[0].Object|d|˜/Files/?url=$_.Location
   In this example, the piped request include three discrete requests: first to get a list of bookmarks, second, to get a content object based on the result of the first discrete request that was executed, and third to download a file based on the result of the second discrete request that was executed.

The piped web request in the above example also includes dependency information. In that request, the text “$_” refers to the result of the discrete request that was most recently executed. As such, the text “$_{—}[0]” in “˜/Contents/$_{—}[0].ObjectId” indicates that element at location [0] of the array (i.e. the first element of the array) should be used in the second discrete request, which is to get a content object. Similarly, the text “$_” in the third discrete request “˜/Files/?url=$_.Location” references to the result of the previous discrete request (i.e. the content object) such a file based on the result of the content object is downloaded. As such, the server processor de-pipes this request to produce a number of discrete, which in this case must be executed in a specific order (i.e. first, second, then third).

The server processor 40 is adapted to de-pipe the piped web request 34. That is, when the web request 34 is received, the server processor is adapted to unwrap the routing information (which generally includes the return address) and extracts the discrete requests provided in the web request. The server processor is also adapted to determine the dependency between the discrete requests to determine the order of execution. For example, a discrete request that is dependent on a result of another request can only be executed after the result of the second request is received. In other examples, some of the discrete requests may be dependent on multiple requests and some discrete requests may not be dependent on any request.

The server processor is also adapted to execute the discrete requests. In some embodiments, the discrete requests A,B,C, are processed to generate commands associated with the discrete requests as described below, prior to execution.

In some embodiments, the server processor may have multiple cores and execute some commands/discrete requests in parallel in the multiple cores. In some embodiments, there may be more than one server processor 40 and some commands/discrete requests may be executed in parallel at multiple server processors. In some embodiments, a processor other than a server processor may be provided for executing the discrete requests/commands.

After the discrete requests are executed, the server processor 40 then provides a response to the client 12, 14, 16 that provided the request based on one or more of the results of the discrete request. For example, as shown, the response “Z” as generally indicated by reference numeral 68, is provided to the client module 32 as a response to the piped request 34. Generally, the processor will need to process the response to include routing information (e.g. HTTP wrappers) so that the response is addressed to the right recipient. In some embodiments, the response may be provided to the client 12, 14, 16 that provided the piped request. In other embodiments, the response may be addressed to another client, server, or there may not be any response at all.

The nature of the response may also vary depending on the nature of the request. In some embodiments, the response may be result of one or more discrete requests that were executed. In some embodiments, the response may be a confirmation that an action has taken place. In other embodiments, the nature of response may be different.

As shown, both the piped request 34 and the response 36 have HTTP routing information for transmitting the request and the response to the server 20 and the client(s) 12, 14, 16 respectively.

In some embodiments, the server processor 40 is adapted to provide a pipe controller module 42 and a discrete request processing module 44. The pipe control muddle 42 is generally operable to receive piped requests, de-pipe each piped request, determine order of execution, general commands for execution based on the order and submit the generated commands to the discrete request processing module 44 for execution, and prepare a response to the submitted client when the discrete requests have been executed. The discrete request processing module 44 is generally operable receive commands from the pipe controller module 42.

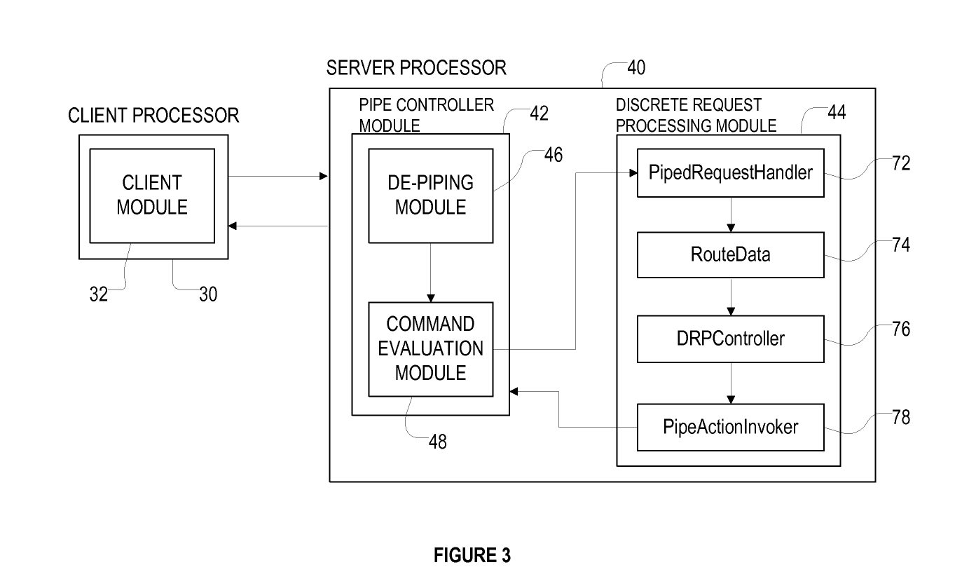

Referring now to FIG. 3, illustrated therein are sub-modules of the pipe controller module 42 and the discrete-request processing module 44 which may be present in some embodiments.

As shown, the pipe controller module 42 comprises a de-piping module 46 and a command evaluation engine 48.

The de-piping module 46 is operable to receive one or more piped requests from the client processor 30 de-pipes the discrete requests A, B, and C nested therein as described above. In some embodiments, the de-piping module 46 may generate an array of discrete requests after extracting the requests.

The command evaluation engine 48 is in data communication with the de-piping module 46 and is adapted to generate a command for each of the discrete requests as extracted by the de-piping module 46. For example, for the first discrete request A, the command generated may be command “C_{A}( )”, as generally indicated by reference numeral 52 shown in FIG. 2.

In some embodiments, the commands generated by the command evaluation engine 48 are provided to the discrete request processing module 44 for execution. In other embodiments, the commands may be executed by modules other than the discrete request processing module 44. In some embodiments, the discrete request processing module may also process non-piped web service requests in addition to the commands/discrete requests from piped web service requests.

The discrete processing module 44 is operable to receive each command, and execute that command to generate the corresponding result associated with that command. For example, the result associated with the command 52 may be result “X”, as generally indicated by reference numeral 62 as shown in FIG. 2. For example, if a functional task is to return the names of students whose grade point average (GPA) is above 4.0 for any history class, then discrete requests could be: i) to obtain a list of history classes, ii) to obtain a list of students in the history classes, iii) to obtain GPA of each student in the history class, and iv) to identify for students that have a higher than 4.0 GPA. In that example, the result of the first discrete task is used in the second discrete task, the result of the second task in the third and so forth.

In some embodiments, the command generated by the command evaluation engine 48 may be a piped HTTP request. The piped HTTP request may be similar to a HTTP request. For example, the piped HTTP request may include information specific to enable the discrete request processing module 44 to return the result to the pipe evaluation engine.

In some embodiments, the command generated by the command evaluation engine 48 is generated based on the result of a command that was executed earlier, and another discrete request. For example, command “C_{B}(X)”, indicated by reference numeral 54, is generated based on discrete request “B” and the result “X” (indicated by reference numeral 62) of the previous command 52. Similarly, command C_{C}(Y), indicated by reference numeral 56, is generated based on the discrete request “C” and a result “Y” (indicated by reference numeral 64) of the command 54.

In some embodiments, the discrete request processing module 44 may be implemented based on the ASP.NET (“dot NET”) Model View Controller (“MVC”) framework provided by Microsoft. For example, the discrete request processing module 44 may be developed based on existing classes/modules/methods provided by the ASP.NET framework. In particular, the discrete request-processing module 44 may be implemented by extending the classes/modules/methods provided by the ASP.NET framework.

In some embodiments, the discrete request processing module 44 may include a pipedRequestHandler module 72. The pipedRequestHandler module 72 may be provided based on the MvcRouteHandler class provided by the ASP.NET MVC framework. In some embodiments, the pipedRequestHandler 72 module extends the MvcRouteHandler class. The pipedRequestHandler module 72 provides a method (“CreateContext”) based on the HttpContextBase that sets up the HTTP environment for processing the commands 52, 54, 56 received from the command evaluation engine.

In some embodiments, the discrete request processing module 44 may include a RouteData module 74, which is an ASP.NET MVC 2 object.

In some embodiments, the discrete request processing module 44 may include a Discrete Request Processing Controller module 76 (“DRPController”). The DRPController module 76 may be provided by extending the Controller class provided by ASP.NET MVC framework. For example, the DRPController module 76 may provide a PipeActionInvoker module 78 instead of the ControllerActionInvoker provided by the ASP.NET MVC framework.

In some embodiments, the discrete request processing module 44 includes the PipeActionInvoker module 78. The PipeActionInvoker module 78 may be implemented by extending the ControllerActionInvoker provided by the ASP.NET MVC framework. The ControllerActionInvoker as provided by the ASP.NET MVC framework implements IActionInvoker, which includes the InvokeAction method. The InvokeAction method generates a Boolean object as the result when the received command 52, 54, or 56 is executed. However, the PipeActionInvoker module 78 includes a method (“InvokePipeAction”) that generates a logical object (“ActionResult” object) as the result associated with the executed received command 52, 54, or 56. The ActionResult object is a logical object (an ASP.NET MVC 2 object) while the result of the InvokeAction is a Boolean object. When the discrete request processing module 44 process commands/discrete requests from a piped request, the InvokePipeAction method is used instead of the InvokeAction method.

Using a server-side object, e.g. the ActionResult object, to communicate between the discrete processing module 44 and the pipe controller module 42 may reduce some overhead processing in that it may not be necessary to process the object for transmittal between the modules. In contrast, if the object were being transmitted to the client processor 30, it would be necessary to include various routing protocols to deliver the object over the Internet to the client processor 30.

In some embodiments, the discrete request processing module 44 is operable to provide the generated result (e.g. the ActionResult object) to the pipe controller module 42 by storing the result in the data storage device at a particular location and the pipe controller module 42 is operable to receive the result by referencing the result that is being stored at the particular location.

It should be noted that even though various functional modules and sub-modules are illustrated and described herein, it may be possible to combine, remove, or modify the one or more of the modules and/or sub modules in other embodiments. That is, the server processor may use different modules or use other programming paradigms to implement the embodiments described herein.

According to another embodiment, there is provided a computer implemented web-service method 100 for providing web-services to a client processor. In some embodiments, the method 100 can be implemented by server processors such as the web server processor 40. In other embodiments, the method 100 can be implemented by one or more other server processors.

The method 100 begins at step 102. At step 102, at least one piped request comprising a plurality of discrete requests is received. In some cases the piped request may be received from one or more web clients. The web client may, in some embodiments, be the same as the web client 12, 14 and 16 described herein and shown. In other embodiments, the number and type of web clients may differ.

At step 104, each discrete request from the piped request is de-piped. The de-piping step may include extracting each discrete request from the piped request. In some embodiments, the extracted discrete request may be stored in an array of discrete requests.

In some embodiments, the piped request may be de-piped by a de-piping module. For example, the de-piping module 46 described herein above may be implemented to perform step 104.

In some embodiments, step 106 may be provided to process a discrete request for execution. For example, a command evaluation engine, (e.g. the command evaluation engine 48 described above) may be used to generate a command based on the discrete request for execution. In some embodiments, the command may be generated based on one of the discrete requests and a result of another discrete request that has been executed.

At step 108, one of the discrete requests is executed to generate a result associated with the discrete request. For example, the command generated by the command evaluation engine in step 106 may be executed. In some embodiments, the discrete request/command may be executed by a discrete request processing module (for example the discrete request processing module 44 described above).

In some embodiments, the result provided by step 108 may be a logical object (e.g. the logical object described above).

At step 110, it is determined whether there exists another discrete request to be executed. If another discrete request exists, the method 100 then returns to step 106. Otherwise, the method 100 proceeds to step 112.

At step 112, at least one response to the one piped request is generated based on at least one of the results generated. This may include inserting additional HTTP wrappers and/or other routing information.

The embodiments described above may entail certain advantages. For example, only one request and response may be required to achieve a functional task. This may prevent multiple round-trips of requests and responses between a web client and a web server in order to achieve the task. By reducing the number of round-trips, the web server and the web client may also reduce overhead processing costs associated with wrapping and unwrapping routing information.

Reducing the number of requests/responses also reduces network traffic. Reducing the number of requests/responses may also improve response time associated with completing a function ask, particularly if the network connection is relatively slow.

Additionally, from a software developer's point of view, the embodiments described herein may be more efficient, as they may require less code to be written as it may not be necessary to provide a web request dedicated to each functional task.

While the above description provides examples of one or more apparatus, methods, or systems, it will be appreciated that other apparatus, methods, or systems may be within the scope of the present description as interpreted by one of skill in the art.

1. A web service system, comprising:
at least one client processor adapted to generate and transmit at least one piped request comprising a plurality of discrete requests;
at least one server processor in data communication with the client processor, the at least one server processor adapted to:
receive the at least one piped request comprising the discrete requests,
de-pipe each discrete request from the piped request; and
execute each discrete request to generate a result associated with the discrete request.

2. The system of claim 1, wherein the server processor is further adapted to generate and transmit at least one response to the one piped request based on at least one of the results generated.

3. The system of claim 2, wherein the server processor is adapted to provide a discrete request processing module operable to:
receive at least one of the discrete requests; and
execute the received discrete request to generate the result associated with that request.

4. The system of claim 3, wherein the server processor is adapted to provide a pipe controller module, and the discrete processing module is operable to:
receive the at least one piped request comprising the discrete requests;
de-pipe each discrete request from the piped request;
provide each discrete request to the discrete-request processing module; and
generate and transmit at least one response to the one piped request based on at least one of the results associated with the executed discrete requests.

5. The system of claim 4, wherein the pipe controller module is operable to generate a command associated with at least one of the discrete requests and provide the command to the discrete request processing module, and the discrete request processing module is operable to receive the command and execute the command to generate the result associated with that discrete request.

6. The system of claim 5, wherein the pipe controller module is adapted to generate the command based on at least one of the discrete requests and at least one of the results that has been previously generated by the discrete-request processing module.

7. The system of claim 1, wherein the at least one piped request is a web request for transmission over the Internet.

8. The system of claim 7, wherein the web request is compatible with hypertext transfer protocol (“HTTP”).

9. The system of claim 3, wherein the discrete request processor module is based on a model-view-controller (MVC) pattern for web applications based on ASP.NET framework.

10. The system of according to claim 4, wherein the discrete request processing module is operable to provide the generated result to the pipe controller module by storing the result in the data storage device at a particular location and the pipe controller module is operable to receive the result by referencing the result that is being stored at the particular location.

11. The web service system of claim 1, wherein the result generated by the discrete request processor module is a logical object.

12. The web service system of claim 1, wherein the discrete request processor module comprises a piped request handler sub-module for setting up an HTTP environment for processing the discrete request.

13. A web server comprising at least one server processor adapted to:
receive the at least one piped request comprising the discrete requests,
de-pipe each discrete request from the piped request; and
execute each discrete request to generate a result associated with the discrete request.

14. The server of claim 13, wherein the server processor is adapted to generate and transmit at least one response to the at least one piped request based on at least one of the results generated.

15. The server claim 13, wherein the server processor is adapted to provide a discrete request processing module, the discrete processing module being operable to:
receive at least one of the discrete request; and
execute the received discrete request to generate the result associated with that request.

16. The server of claim 14, wherein the server processor is further adapted to provide a pipe controller module operable to:
receive the at least one piped request comprising the discrete requests;
de-pipe each discrete request from the piped request;
provide each discrete request to the discrete-request processing module; and
generate and transmit at least one response to the one piped request based on at least one of the results associated with the executed discrete requests.

17. The server of claim 16, wherein the pipe controller module is operable to generate a command associated with at least one of the discrete request and provide the command to the discrete request processing module, and the discrete request processing module is operable to receive the command and execute the command to generate the result associated with that discrete request.

18. The server of claim 17, wherein the pipe controller module is adapted to generate the command based on at least one of the discrete requests and at least one of the results that has been previously generated by the discrete-request processing module.

19. The server of claim 13, wherein the at least one piped request is a web request for transmission over the Internet.

20. The server of claim 13, wherein the web request is compatible with hypertext transfer protocol (“HTTP”).

21. The server of claim 15, wherein the discrete request processor module is based on a model-view-controller (MVC) pattern for web applications based on ASP.NET framework.

22. The server of claim 16, wherein the discrete request processing module is operable to provide the generated result to the pipe controller module by storing the result in the data storage device at a particular location and the pipe controller module is operable to receive the result by referencing the result that is being stored at the particular location.

23. The server of claim 16, wherein the result generated by the discrete request processor module is a logical object.

24. The server of claim 16, wherein the discrete request processor module comprises a piped request handler sub-module for setting up an HTTP environment for processing the discrete request.

25. A computer-implemented web service method comprising:
receiving at least one piped request comprising a plurality of discrete requests;
de-piping each discrete request from the piped request; and
executing each discrete request to generate a result associated with the discrete request.

26. The method of claim 25 further comprising generating and transmitting at least one response to the one piped request based on at least one of the results generated.

27. The method of claim 25, wherein the step of de-piping each discrete request comprises generating a command associated with at least one of the discrete requests for execution.

28. The method of claim 25, wherein the step of generating the command comprises generating the command based on at least one of the discrete requests and at least one of the results generated by the discrete-request processing module.
